(19) United States
(12) Patent Application Publication
(10) Pub. No.: US 2017/0142948 A1
(43) Pub. Date: May 25, 2017

(54) MEANS AND METHOD FOR EASILY TRANSFERRING FISHING LINE FROM A STORAGE SPOOL TO A FISHING REEL BOTH MOUNTED ON A FISHING ROD

(71) Applicant: CHRISTIAN MORENO, NAPLES, FL (US)

(72) Inventor: CHRISTIAN MORENO, NAPLES, FL (US)

(21) Appl. No.: 15/338,973

(22) Filed: Oct. 31, 2016

Related U.S. Application Data
(60) Provisional application No. 62/386,112, filed on Nov. 19, 2015.

(51) Int. Cl. A01K 89/00; B65H 75/42

(52) U.S. Cl. CPC A01K 89/003; B65H 75/42; B65H 2701/355

(57) ABSTRACT

A portable one piece hanger means comprising a gripping means and a holding means, with the gripping means adapted to readily attach and detach said hanger mean to and from a fishing rod that has a fishing reel attached thereto and with the holding means adapted to support a supply spool of fishing line that rotates on said holding means but is held securely thereon while said holding means exerts a drag on the spool thus tensioning the line as it is fed from the supply spool to the reel while the hanger means is temporarily and securely attached to the fishing rod. The holding means is on the same side of the hanger means as the griping means and the hanger means can be a package when sold with the supply spool as a unit.

### REFERENCES CITED

U.S. PATENT DOCUMENTS

| | | | |
|---|---|---|---|
| 4,922,644 | May 1990 | Sherbondy | 242/406 |
| 5,839,687 | November 1998 | Magnafici | 242/404.3 |
| 4,787,168 | November 1998 | Benit | 43/25.2 |
| 6,609,673 | August 2003 | Johnson | 242/423.1 |
| 6,742,737 | June 2004 | Conner | 242/323 |
| 7,303,164 | December 2007 | Reno | 242/588.4 |
| 9,010,676 | April 2015 | DiCicco | 242/588.3 |

### TECHNICAL FIELD OF THE INVENTION

The present invention is related generally to the field of a fishing line apparatus. It is specifically directed to fishing line dispensers that load fishing line from a supply spool onto a fishing reel that is mounted on a fishing rod.

### BACKGROUND OF THE INVENTION

It is well known to fisherman how to transfer fishing line onto fishing reels from a supply spools. A problem with dispensing fishing line from spools has been the inherent awkwardness one person has in accomplishing this task. The feeding of the fishing line evenly onto a fishing reel may require two people; one person to hold the rod and rotate the reel and a second person to hold and monitor the spool of fishing line.

There are several ways a lone fisherman can dispense fishing line from a spool to a reel. One is by hanging a fishing line dispenser on the fishing rod to dispense line directly onto the reel; but without means for applying friction or drag to the line being dispensed and improper hanging and no tension tangling of the line being dispensed becomes a problem. Without means to secure the storage spool to anything during the transfer creates another problem.

Another way a lone fisherman transfers line from a supply spool to his reel is by simply throwing the spool of line onto the floor of his boat and then reel the line from the spool onto the reel. Obviously the fisherman places the spool on it side or it would roll away. As the line is wound onto his reel he is probably holding the rod handle between his knees and using one hand to turn the reel because he needs the other hand to apply tension to the oncoming line or he will quickly have a loose tangled mess of line on his reel.

Thus there is a need to securely hold the rod while turning the reel handle and to secure the spool and apply tension to the line being transferred onto the fishing reel in a hand winding method.

### OBJECT OF THE INVENTION

The main object of the present invention is to provide a hanging means to transfer fishing line from a supply spool to a fishing reel attached to a fishing rod without backlash of the fishing line by maintaining a slight drag on the line during this transfer and this transfer is accomplished by one person.

This transfer can be carried out by this one person on either a casting reel or a spinning reel.

This transfer can be carried out by one person using a said hanger means which can be sold as a package with the supply spool.

### SUMMARY OF THE INVENTION

The present invention is a fishing line dispenser for facilitating the loading of fishing line, while under tension onto a reel mounted on a fishing rod. It includes a portable one piece hanger means comprising a gripping means and a holding means with the gripping means adapted to readily attach and detach said hanger mean to and from a fishing rod that has a fishing reel attached there to and with the holding means adapted to support a spool of fishing line that rotate on said holding means but is hold securely there on while said holding means exerts a drag on the spool thus tensioning the line as it is fed from the spool to the reel while the hanger means is temporarily and securely attached to the fishing rod.

The invention of this application is, thus, an improved fishing line dispenser for use with fishing rods and reels of various construction. This device will allow the user to virtually not need the help of another person to perform this task. More specific advantages will become apparent with reference to the detailed description of the invention, claims, and appended drawings.

### BRIEF DESCRIPTION OF THE DRAWINGS

FIG. 1 is a view in perspective of a portable one piece hanger means in accordance with the present invention;

FIG. 2 is an exploded perspective view of a portable one piece hanger means illustrated in FIG. 1 with elements shown; and a fishing line spool.

FIG. 3 is a side view of a vertical cross section taken of FIG. 1, FIG. 3a is a top view of FIG. 1 and FIG. 3b is a top view magnification of the bifurcated one piece holding means of FIG. 1

FIG. 4 is an elevational view of the package comprising a spool of fishing line attached to the portable one piece hanger means.

FIG. 5 is a side view in reduced scale of the invention (the portable one piece hanger means) in its position of use on a fishing rod with an attached spinning reel.

FIG. 6 is a side view of the invention in another position of use attached to a fishing rod with a closed reel (casting reel).

### DETAILED DESCRIPTION OF THE PREFERRED EMBODIMENT OF THE INVENTION

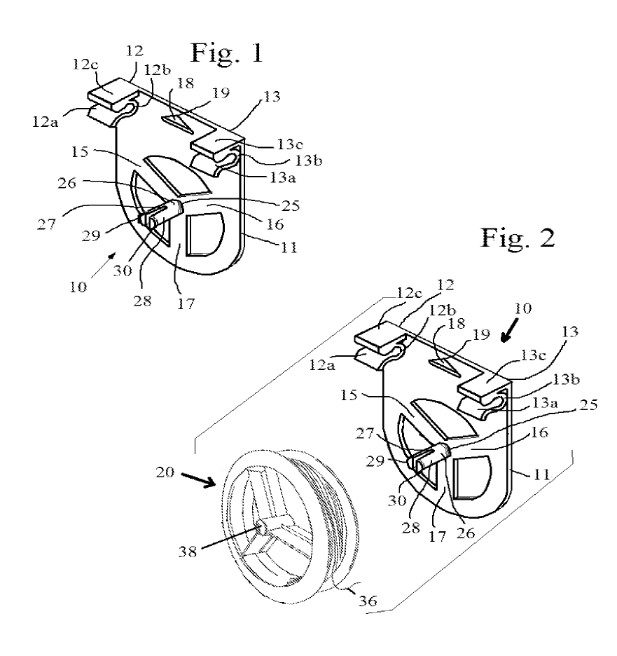

Show in FIGS. 1-4 is portable one piece hanger means 10 of the present invention. The hanger means 10 is releasable but securely attached to a fishing rod and also supports a fishing line supply spool. The hanger means 10 enables fishing line to be unloaded from the supply spool onto the reel which is attached to the rod permitting one person to perform the process of transferring the line onto the reel in a neat orderly manner thus eliminates any snagging and loose loading onto the reel at the fisherman's convenience and enabling him to have both hands free to hold the rod and turn the reel with excellent results.

More specifically, hanger means 10 is a one piece member that includes a base member 11 with gripping means 12 and 13 and holding means 25 fixed to the same side of the base member 11.

Aside from the gripping means 12 and 13 and holding means 25 the base member is made up of 3 spokes 15, 16 and 17 that are part of the base member 11 and the help support the holding means 25.

The base member 11 also has a cut out notch 18 with an apex 19 that is usable as a area to hold the hanger means 10 over a nail or hook (not shown) for display purposes in a store or to store it on a peg board or hook in a fisherman's boat or in his garage or basement.

The base member 11 also include spaces between the three spokes 15, 16 and 17 that the fisherman can reach his thumb and finger or two fingers through enabling him to touch the holding means 25 as he loads a fishing line spool 20 onto the hanger means 10 so that the said spool can be secured to the holding means 25 and hanger means 10 can be securely and firmly attached to a fishing rod 21 and then fishing line can be quickly and precisely transferred from the spool 20 to either a fishing reel 22 or 22a that is attached to the same fishing rod 21 as the hanger means 10.

Specifically the gripping means 12 and 13 comprise static members 12c and 13c respectively that are part of the hanger element. Each static member 12c and 13c has a flexible arm 12a and 13a respectively and each has a flexible U-shaped elbow 12b and 13b respectively. Those elbow 12b and 13b being the flexible connecting link between static members 12c and 13c and the respective arms 12a and 13a.

The two gripping means 12 and 13 that securely and readily attach the hanger means 10 to a fishing rod have the flexibility in arms 12a and 13a to hold onto the fishing rod even though the rod itself changes diameter as it approaches the reel end at the rod. The arms 12a and 13a flex at elbows 12b and 13b where the arms 12a and 13a are snapped over the fishing rod the arms 12a and 13a then securely hold the rod between the arms 12a and 13a and static members 12c and 13c respectively .

Detaching is accomplished by simply and manually pulling the entire hanger means from the rod because the arms 12a and 13a will flex at elbows 12b and 13b respectively and the hanger means will snap off the rod as readily as it was attached.

More specifically the portable one piece hanger means 10, shown in FIGS. 1-6 further includes in the central part a holding means 25 comprising a shaft means 26 that includes a bifurcated end, two tines 27 28 and each tine has a lip at its free end 29 30. Holding means 25 and gripping means 12 and 13 are formed on the same side of the hanger means 10. Shaft 26 is surrounded by three spokes 15 16 and 17 as an integral part of the portable one piece hanger means 10.

Again the gripping means of the hanger means comprises flexible arm clamp means 12 13 at each end of the hanger means 10 to readily attach and detach the hanger means to and from said fishing rod 21. The said arm clamp means gripping means 12 13 comprises flexible U shaped members 12b 13b respectively that frictionally snaps over the fishing rod 21. These flexible arm clamp means 12 13 are formed on the same side of the hanger means 10. A notch cut out area 18 with an apex 19 formed in the hanger means 10 will provide means to mount the portable one piece hanger means 10 from a display hook, not shown. The portable one piece hanger means 10 is a useful display package which, because of its simple construction and less expensive cost can be provided to a customer with each spool of line sold.

As can be seen illustrates in FIG. 2 the element of the portable one piece hanger means 10 of FIG. 1 along with the storage reel 20. The elements and their orientation within hanger means 10, are shown. Fishing line 36 is wound on spool 20, and the hub 38 of spool 20 is engaged by the holding means 25 to the hanger means 10 thus supporting the spool securely and providing drag to the fishing line 36 as it is drawn from said spool 20, to the reel which is attached to the fishing rod.

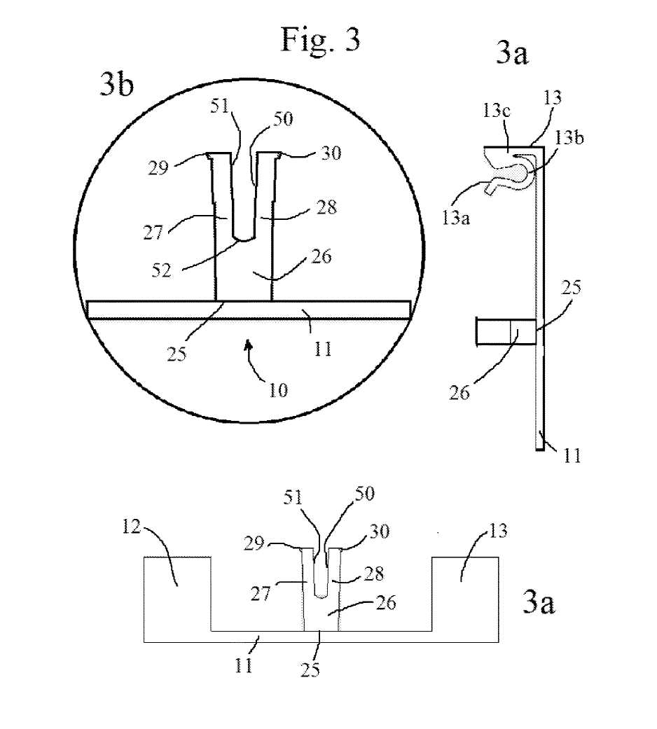

As can be seen FIG. 3 shows a side cross section view of hanger means 10 and FIG. 3a shows at top view of the portable one piece hanger means and finally FIG. 3b discloses a magnified, fragmentary top view of the holding means 25 of the hanger means 10.

Further shown in FIG. 3 The holding means 25 comprises a central shaft 26 that is attached to the base member 11. The central shaft 26 is cylindrical for nearly half its length from the base member outward then the shaft become bifurcated to its ends. The two tines of the bifurcation are tine 27 and 28. Each tine has a lip 29 and 30 respectively at its end. The tines are spaced from each other and also diverge away from each other at their lip ends. The lips each have a greater diameter than the tines 27 and 28 and the central shaft 26. This increase in diameter is what creates a lip at the end of each bifurcated tine.

These lips stops the storage spool from sliding off the central shaft as the spool rotates in it transfer of fishing line onto the fishing rods reel.

Between the tines 27 and 28 is an open area creating inner wall 50 in tine 28 and on tine 27 an inner wall 51. At the inner end or convergence of these walls 50 and 51 is base 52 which can be U shaped or V shaped without reducing the effectiveness of the tines. The preferable form for base 52 is a U shape because it more readily enables the fisherman to squeeze the tines together to load the storage spool onto the central shaft 26. The original shape of the central shaft 26 with its tines and U shaped opening 52 increases the diameter of the central shaft 26 as it extends toward the lip stops. The lip stops have a larger diameter than the base of the central shaft 26 and as the tines move toward the lips from the base of the central shaft 26 they also become larger in diameter like two fingers opening thus enabling the shaft to exert drag on the spool after they are attached. Thus keeping the fishing line snug between the spool 20 and the fishing reel 22 or 22a as the line is easily unloaded from the spool to the reel.

This divergent spacing of the tines enables them to apply a light dragging force on the inside axis wall of hub 38 of the fishing line holding spool 20. The holding spool 20, is fitted onto the central shaft 26 by pinching the tines together, with your fingers, inserted through the open slots created between spokes 15,16 and 17 as the spool is placed onto the central shaft 26.

When the tines are released they will expand to their original divergent position that will naturally place friction on the inside of the spools cylindrical shaft hub 38 wall and thus creating a drag on the fishing line being loaded onto the fishing rods reel 22 or 22a from the storage spool 20. This drag will result in a tight fishing line transformation of the new fishing line onto the rods reel avoiding snags and tangling of the line and enabling the fisherman to hold the fishing rod with one hand and turn the reel with the other hand to load the fishing line precisely and easily from the spool 20, to the reel without using a third hand to hold the spool; because, the spool is securely attached to the fishing rod by the gripping means 12 and 13 at the top of the hanger means 10. The storage spool 20 of fishing line is therefore rotatably secured on the central shaft 26 of the hanger means 10 and in its secure rotating position the drag is constantly maintained by the bifurcated tines 27 and 28 of central shaft 26. To make sure the storage spool is held in place and rotating each tine 27 and 28 has a respective lip 29 and 30. The lip 29 and 30 are each semi circular and each is part of it's tine 27 and 28.The lips stick out over the end edge of the storage spool central hub 38 and thus secure the storage spool onto the central shaft 26 allowing the storage spool to spin on the shaft and be held on the shaft while placing drag on the spool insuring the line transfers from the spool to the rod without snags or any tangling of the line thus enabling the fisherman to load or reload line onto his reel while using one hand on the rod and the other on the reel and turning the reel thus loading line from the spool quickly easily, safely and without the frustration of the storage spool not holding in place during the operation.

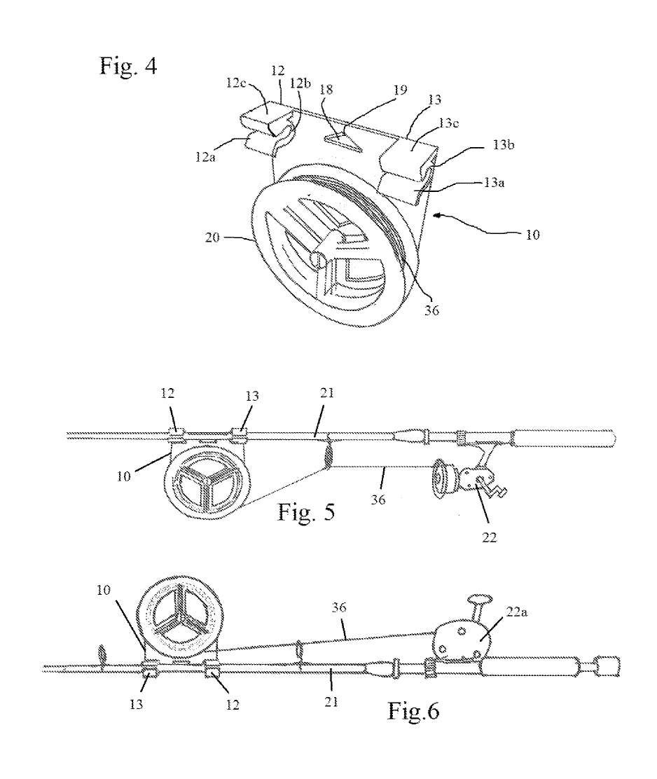

FIG. 4 is an elevational view of the spool 20 of fishing line attached to the portable one piece hanger means 10.

FIG. 5 and FIG. 6 illustrate the portable one piece hanger means 10 of this invention in its position of use mounted on a shaft of fishing rod 21 perfectly secured, positioned up or down so as may be required by the user. The fishing line 36 is being dispensed from the portable one piece hanger means 10 dispenser, onto the fishing reel 22 or 22a.

This invention is novel in other way; because it comprises a package made up of the one piece hanger means 10 and spool of fishing line 20. The package can be purchased at a sports store and immediately and securely attached to a fishing rod and the fishing line can be attached to the reel of the rod and fishing line can then be transferred from the spool to the reel on the rod using one hand to hold the rod and the other hand to wind the reel thus transferring fishing line from the spool to the reel quickly and trouble free. When the reel is full the entire package can be easily removed from the rod and stored and when more line is needed the package can be easily secured again to any rod and the reel can be filled. When the spool is empty the package can be easily removed and discarded into the trash.

Other modifications of the invention will be apparent to those skilled in the art in light of the foregoing description. This description is intended to provide specific examples of a preferred embodiment of the present invention. Accordingly, the invention is not limited to the embodiment shown or the use of elements having specific configurations and shapes as presented herein. Alternative modifications and variations of the present invention which follow in the spirit and broad scope of the appended claims are included.

What is claimed is:

1. A device for transferring fishing line from a supply spool to a fishing reel having a portable one piece hanger means comprising a gripping means and a holding means wherein the gripping means is adapted to readily attach and detach said hanger means to and from a fishing rod that has said fishing reel attached thereto and with the said holding means adapted to support the said supply spool of fishing line that rotates on said holding means that is held securely thereon while said holding means exerts a drag on the supply spool thus tensioning the line as it is fed from the supply spool to the said fishing reel while the hanger means is temporarily, stably and securely attached to the fishing rod wherein the one piece hanger means is releasably but stably and securely attached to said fishing rod and also supports the fishing line supply spool whereby fishing line is fed from the said supply spool to said fishing reel that is mounted on the said fishing rod.

2. The device of claim 1 wherein the said gripping means comprises a member that securely and stably attaches said hanger means to said fishing reel, said member comprising a U-shaped flexibly biased means whereby said gripping means is stably and securely fixed onto said fishing rod even though the rod itself changes diameter as it approaches the reel end at the rod

3. The device of claim 2 wherein said member comprises a static member and a flexible arm connected together by a U-shaped elbow which is the flexible link between the said static member and the said flexible arm.

4. The device of claim 2 wherein the said gripping means comprises at least two said members.

5. The device of claim 1 wherein the said holding means comprises a central shaft attached to said base and is cylindrical in cross section for a portion of its length from the said base member outward then and there after the said shaft becomes divided.

6. The device of claim 5 wherein said central shaft is cylindrical in cross section for nearly half its length from said base member outward, then and thereafter the said shaft is bifurcated.

7. The device of claim 6 wherein said bifurcated members comprises two tines and each tine includes a lip at its end whereby the lips prevent the said storage spool from sliding off the central shaft as the said storage spool rotates.

8. The device of claim 7 wherein said tines increase the diameter of the said central shaft as they extend toward their lip stops.

9. The device of claim 8 wherein said diameter of said tines comprising said central shaft toward said lip stops being larger than the inner diameter of the central bore of said supply spool mounted thereon and thereby flexibly engage said central bore of said supply spool when said spool is mounted on said central shaft and thereby exert drag on the said supply spool, thus keeping tension on said fishing line between the said spool and the said fishing reel.

10. The device of claim 1 wherein the said one piece hanger means has a base member comprised of spokes that help support the said holding means.

11. The device of claim 10 wherein said hanger means incorporates a cut out notch therein for hanging and displaying the said device.

12. The device of claim 2 wherein said holding means and said gripper means are mounted on the same side of the hanger means
